(19) United States
(12) Patent Application Publication
(10) Pub. No.: US 2004/0086614 A1
(43) Pub. Date: May 6, 2004

(54) Method for the pasteurization of liquid mixtures for the manufacture of ice cream

(76) Inventors: Gino Cocchi, Bologna (IT); Gianni Zaniboni, Borgonuovo Di Sasso Marconi (IT); Roberto Lazzarini, Reggio Emilia (IT)

Correspondence Address: STITES & HARBISON PLLC, 1199 NORTH FAIRFAX STREET, SUITE 900, ALEXANDRIA, VA, 22314, US

(21) Appl. No.: 10/685,467

(22) Filed: Oct. 16, 2003

(30) Foreign Application Priority Data
Oct. 30, 2002 (IT) GE2002A000100

(51) Int. Cl. A23L 3/16

(52) U.S. Cl. 426/521

(57) ABSTRACT

Method for the pasteurization of liquid mixtures for ice cream, characterised by the following stages: heating of the liquid mixture to a temperature below the coagulation point for the protein substances present in the liquid mixture and the simultaneous injection of pressurized gaseous carbon dioxide into the liquid mixture. The processing temperature lies between approximately 50° C. and approximately 59° C. and is preferably in the order of approximately 55° C. Injection of the gaseous carbon dioxide takes place at a pressure which may be varied between approximately 5 and approximately 6 bar and preferably at a pressure of approximately 5.5 bar.

### FIELD OF THE INVENTION

This invention relates to a method for the pasteurization of liquid mixtures for the manufacture of ice cream. More particularly the invention relates to a method for the sterilization of liquid mixtures for ice cream for machines for the manufacture of ice cream of the type known as “soft”. In particular this method is especially suitable for use in machines for the manufacture of ice cream which use either containers containing a flexible bag placed in a box (“bag in box”) or pressurized containers to contain the liquid mixture for ice cream.

### BACKGROUND OF THE INVENTION

As is known, liquid mixtures for ice cream are normally pasteurized using treatments of the thermal type, comprising heating the liquid mixture for ice cream to a temperature of around 65-85° C., followed by cooling. Treatments of this kind have various disadvantages, including the fact that the organoleptic properties (colour, smell, flavour, etc.) and nutritional properties of the ice cream produced may be adversely affected. In fact coagulation of the protein substances present in liquid mixtures for ice cream already occurs at a temperature of approximately 60° C. with consequent changes in the taste and digestibility of the ice cream produced using such liquid mixtures. On the other hand pasteurization treatments are necessary because such liquid mixtures for ice cream may be contaminated by a number of bacteria, in particular staphylococci, coliforms, enterococci and others which find these liquid mixtures with a high sugar and protein content to be a particularly favourable culture medium for their growth.

The object of this invention is therefore to overcome the disadvantages of known thermal pasteurization treatments using a method for pasteurizing liquid mixtures for ice cream which is simple and economic and to make it possible to maintain the organoleptic and nutritional properties of the ice cream produced thereby unchanged while at the same time destroying any bacterial load which may be present in the liquid mixture or ice cream, effectively inhibiting growth of the bacteria.

It is known that the main factors which can influence bacterial growth, retarding it or inhibiting it, or even bringing about destruction of the bacterial load are:

1) temperature, which beyond particular limits brings about the disadvantages mentioned above,

2) chemical-physical factors, in particular the effect exerted by the pH of the medium. In fact bacteria normally prefer pH values lying within the sub-acid-neutral-alkaline range.

### SUMMARY OF THE INVENTION

Surprisingly it has been discovered that subjecting liquid mixtures for ice cream to treatment comprising heating to temperatures below 60° C. with the simultaneous injection of gaseous carbon dioxide at a pressure above atmospheric into the liquid mixtures for a time varying according to the liquid mixture being treated, but which is advantageously of the order of 3 to 6 hours, brings about complete sterilization of the liquid mixtures without the disadvantages of conventional processes.

It is thought that this result may be due to a synergistic effect arising from the combination of: (a) heat, although below the threshold generally considered to be essential to achieve pasteurization of such liquid mixtures, (b) the pressure of the CO₂ which, as is known, can destroy bacterial cell walls. It may also be thought that the formation of carbonic acid within the liquid mixture tends to displace the pH of the liquid mixture into the acid range.

The main object of this invention is therefore a method for the pasteurization of liquid mixtures for ice cream comprising the stages of heating the liquid mixture to a temperature below the coagulation temperature of the protein substances present in such a liquid mixture, with the simultaneous injection of gaseous carbon dioxide at a pressure above atmospheric into the liquid mixture.

Further objects, features and advantages of this invention will become evident in the course of the following description which is provided by way of a non-restrictive example.

### Description of the Machines Used for Converting the Liquid Mixtures for Ice Cream According to the Invention Into Ice Cream

Because the liquid mixtures for ice cream pasteurised using the method according to the invention can be used in any machine for the manufacture of ice cream, this method is particularly suitable for use in combination with non self-pasteurising ice-cream machines of the type in which (a) the liquid mixture is delivered from containers placed in a flexible bag (known as “bag in box”) fitted with an attachment for a tube connected to the suction side of a pump whose output is connected to the cylinder of the machine producing the soft ice cream, or (b) machines of the type in which the liquid mixture is contained in pressurized tanks which can be connected to the cylinder of the machine producing the soft ice cream. In the course of the description below the invention is illustrated as being applied to a pressurized machine for the manufacture and delivery of ice cream of the soft type, of the type for example of the machine which is the subject matter of U.S. patent application Ser. No. 10/137,320 by the same applicant. A machine of the “bag in box” type is instead illustrated and described for example in the U.S. patent application Ser. No. 10/452,151 by the same applicant.

### BRIEF DESCRIPTION OF THE DRAWING

FIG. 1 of the appended drawing illustrates a perspective view with parts in cross-section of a container for feeding liquid mixtures for ice cream into pressurized machines connected to a cylinder of carbon dioxide gas for processing the liquid mixture contained therein by the method of pasteurization according to this invention.

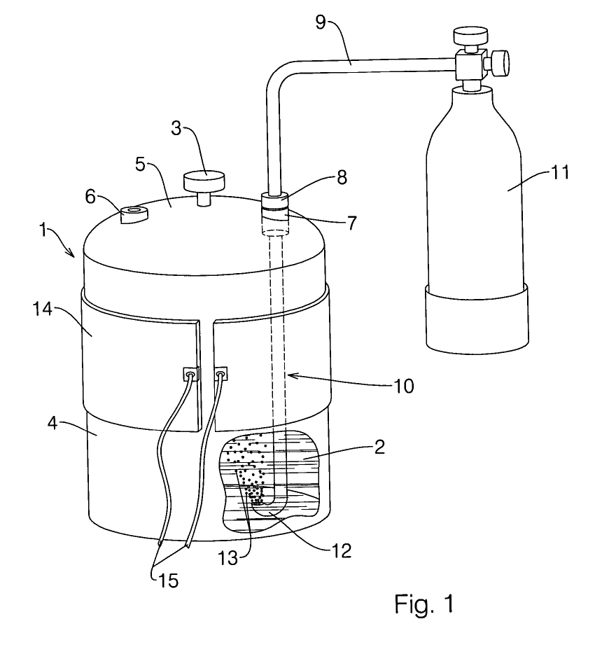

### DESCRIPTION OF THE PREFERRED EMBODIMENT OF MACHINE USED IN CARRYING OUT THE METHOD ACCORDING TO THE INVENTION

With reference to this drawing, 1 indicates a container for pressurized machines in which a mixture 2 in the liquid state for the manufacture of ice cream is placed through leaktight stopper 3. This container 1 comprises a metal cylinder which is sealed at the top by a hemispherical shell 5 in which two seats 6 and 7 for leaktight quick-fit connections are provided in addition to said stopper 3. In particular seat 7 receives a quick-fit connection 8 provided at the end of a tube 9 drawing carbon dioxide from a delivery cylinder 11. Within container 1 there is a pipe 10 which is connected at the top to seat 7 of quick-fit connection 8 and which has at its lower end an upwardly curving length 12 located almost at the bottom of container 1 through which the gaseous carbon dioxide is caused to bubble through liquid mixture 2 in the form of small bubbles 13. A flexible electrical resistance heating member 14 provided with corresponding electricity supply cables 15 is fitted around the cylindrical wall of container 1.

### The Pasteurization of Liquid Mixtures in the Pressurisable Container

Once liquid mixture 2 has been placed in container 1 it is heated by electrical resistance strip 14 and then carbon dioxide under pressure fed from cylinder 11 is injected into container 1. This heating is thermostatically controlled to temperatures below 60° C., in particular to temperatures lying between 50-59° C. and preferably approximately 55° C., as will be described below in the examples. The pressure of the carbon dioxide from cylinder 11 is regulated to a pressure of approximately 5-6 bar, preferably 5.5 bar. This treatment is continued for a time which can be varied between approximately 3 and approximately 6 hours. At the end of the treatment the container with the liquid mixture can be placed in a pressurized machine for the manufacture of ice cream in a known way.

The results of some tests on the method of pasteurizing liquid mixtures for the manufacture of ice cream according to this invention are described below by way of a non-restrictive example.

### Procedure and Means Used in the Following Tests

The following tests involve the use of suitable substrates to detect any presence of or contamination by saprophytic bacteria present in the environment or in the liquid mixtures used. In this respect LB substrates were used for the total microorganism count, MacConkey Agar substrate (from the MERK company) was used for coliforms, Mannitol Salt Agar (from the DIFCO company) for staphylococci and Azide Maltose Agar (from the BIOLIFE company) for enterococci. A quantity of sample equal to 0.1 ml was uniformly distributed over each culture plate. Serial dilutions were made on the basis of potential contamination taking 1 ml of each sample of ice cream and diluting it in 9 ml of physiological saline. The plates were incubated in air at a temperature of 37° C. Any growth of coliforms was evaluated after 24 hours and any growth of enterococci and Staphylococcus Aureus was evaluated after 48 hours.

### Conduct of the Tests

In all the tests a container 1 of the required capacity (generally 5 or 10 litres) was washed out manually with a detergent solution and a sterilizing solution. Container 1, to the jacket of which heating strip 14 was applied, was filled with the quantity of liquid mixture specified for the test inoculated with a suitable bacterial load.

### Test 1

4 litres of a liquid mixture for “Elena” chocolate ice creaminoculated as described were placed in a 5 litre container prepared as described. The following samples were taken for the purposes of the bacteriological check:

CO 0: Mixture inoculated and raised to a temperature of 58° C.

CO 1: Mixture taken from container 1 after 3 hours at 58° C.

CO 2: Mixture taken from container 1 at 52° C. after 4 hours.

CO 3: Mixture taken from container 1 at 53° C. after 6 hours.

The test was carried out with CO₂ being injected at a pressure of 5.5 bar at all times, with an average liquid mixture temperature of 55° C. The test was terminated after 6 hours.

TABLE 1
Results of Test 1
Microbiological examinations carried out on samples in
the first test. Values expressed as number of cells per
gram of sample

| | | S. | | |
|---|---|---|---|---|
| Sample | TML | aureus | Coliforms | Enterococci |
| CO 0: | 10⁵ | 6 × 10⁴ | 3 × 10⁴ | 1 × 10³ |
| inoculated | | | | |
| mixture t = 0 | | | | |
| CO 1: | <10² | <10² | <10² | <10² |
| inoculated | | | | |
| mixture t = 3 h | | | | |
| CO 2: | <10² | <10² | <10² | <10² |
| inoculated | | | | |
| mixture t = 4 h | | | | |
| CO 3: | <10² | <10² | <10² | <10² |
| inoculated | | | | |
| mixture t = 6 h | | | | |

TML = total microorganism load

As will be seen, this test resulted in complete elimination of the inoculum provided after as little as 3 hours.

### Test 2

In this test the object was to check whether the effect of the pressurized CO₂ was also apparent with larger quantities of liquid mixture, that is with approximately 8 litres. 8 litres of liquid mixture of Fiordilatte ice creaminoculated with a suitable bacterial load as previously described were placed in a container 1 having a capacity of 10 litres.

The following tests were carried out for the purposes of the bacteriological check:

CO 4: mixture as placed in container 1

CO 5: mixture heated to a temperature of 58° C.

CO 6: mixture taken from container 1 after 3 hours at 58° C.

CO 7: mixture taken from container 1 at 51° C. after 5 hours

CO 8: mixture taken from container 1 at 54° C. after 6 hours

TABLE 2
Results of test 2
Microbiological examinations carried out on samples in
the second test. Values expressed as number of cells
per gram of sample

| | | S. | | |
|---|---|---|---|---|
| Sample | TML | aureus | Coliforms | Enterococci |
| CO 4: mixture | <10² | <10² | <10² | <10² |
| as such | | | | |
| CO 5: | 6 × 10⁶ | 6 × 10⁴ | 6 × 10⁵ | 6 × 10⁵ |
| inoculated | | | | |
| mixture t = 0 | | | | |
| CO 6: | <10² | <10² | <10² | <10² |
| inoculated | | | | |
| mixture t = 3 h | | | | |
| CO 7: | <10² | <10² | <10² | <10² |
| inoculated | | | | |
| mixture t = 5 h | | | | |
| CO 8: | <10² | <10² | <10² | <10² |
| inoculated | | | | |
| mixture t = 6 h | | | | |

TML = total microorganism load

This second test, carried out using a larger quantity of liquid mixture for ice cream (8 litres) and keeping the pressure conditions for the CO₂, the temperature and the treatment time unchanged from test 1, resulted in total elimination of the inoculum after 3 hours, as well as after 5 and 6 hours.

### Test 3

The purpose of this test was to check that the effect of the pressurized CO₂ was present even if the CO₂ was not intimately mixed with the liquid mixture by causing it to bubble through the mixture, but keeping it in the headspace of the container without mixing it well with the liquid mixture for ice cream.

Test 2 above was repeated with the variant that the attachment for the CO₂ delivery pipe was connected to connection 6 on container 1 instead of connection 7 so that the CO₂ was fed to the top of container 1.

The following samples were taken for the purposes of the bacteriological check:

CO 9: mixture inoculated and raised to a temperature of +50° C. while maintaining the delivery of CO₂ at a pressure of 5.5 bar to the top of container 1 at all times

CO 10: mixture taken from container 1 after 3 hours (+52° C.)

CO 11: mixture taken from container 1 after 4 hours (+50° C.)

CO 12: mixture taken from container 1 after 6 hours (+52° C.)

TEST 3
Results of comparative Test 3
Microbiological examinations carried out on samples in
the second test. Values expressed as number of cells
per gram of sample

| | | S. | | |
|---|---|---|---|---|
| Sample | TML | aureus | Coliforms | Enterococci |
| CO 9: inoculated | >10⁶ | 2 × 10³ | 10 × 10⁶ | 4 × 10⁵ |
| mixture t = 0 | | | | |
| CO 10: | >10⁶ | 27 × 10⁴ | 7 × 10⁶ | 1.5 × 10⁶ |
| inoculated | | | | |
| mixture t = 3 h | | | | |
| CO 7: inoculated | >10⁶ | 27 × 10³ | 8 × 10³ | 33 × 10⁵ |
| mixture t = 5 h | | | | |
| CO 8: inoculated | >10⁶ | 26 × 10³ | 10 × 10⁶ | 15 × 10⁶ |
| liquid mixture | | | | |
| t = 6 h | | | | |

TML = total microorganism load

As will be seen, no decrease in the microorganism load was observed even after 6 hours contact between the pressurized CO₂ and the liquid mixture, so the results of this test demonstrate that pasteurization with CO₂ is only active if the CO₂ is caused to come into intimate contact with the liquid mixture.

We claim:

1. Method for the pasteurization of liquid mixtures for ice cream, comprising the following steps: heating of the liquid mixture to a temperature below the coagulation temperature for the protein substances present in the said liquid mixture and simultaneous injection of gaseous carbon dioxide under pressure into the liquid mixture in intimate contact with the liquid mass of the mixture.

2. Method according to claim 1, in which the said temperature lies between approximately 50° C. and approximately 59° C.

3. Method according to claim 2, in which the said temperature is equal to approximately 55° C.

4. Method according to claim 1, in which the said steps of heating the liquid mixture and injecting the gaseous CO₂ take place simultaneously and for a period of between approximately 3 and approximately 6 hours.

5. Method according to claim 1, in which injection of the said gaseous carbon dioxide takes place at a pressure which can be varied between approximately 5 and approximately 6 bar.

6. Method according to claim 1, in which injection of the said gaseous carbon dioxide takes place at a pressure of approximately 5.5 bar.

7. Method according to claim 1, in which the said gaseous carbon dioxide is caused to bubble through the said liquid mixture being treated.
